(19) United States
(12) Patent Application Publication
(10) Pub. No.: US 2011/0187536 A1
(43) Pub. Date: Aug. 4, 2011

(54) Tracking Method and System

(76) Inventor: Michael Blair Hopper, Worcester, MA (US)

(21) Appl. No.: 13/019,871

(22) Filed: Feb. 2, 2011

Related U.S. Application Data
(60) Provisional application No. 61/300,592, filed on Feb. 2, 2010.

(51) Int. Cl. G08B 23/00

(52) U.S. Cl. 340/573.1

(57) ABSTRACT

A lighting system and method is provided for tracking movement within a predetermined area. This system includes a plurality of lights installed at predetermined locations throughout the predetermined area, each having at least one sensor with a field of view. The lights include a computing module operatively associated with each sensor, and a communication module operatively associated with the computing module. The lights are configured to communicate with one another and capture sensor output to identify and record points at which the fields of view overlap with one another, to form a unified sensor network having a composite field of view.

### RELATED APPLICATION

This application claims the benefit of U.S. Provisional Application Ser. No. 61/300,592, entitled Tracking Method and System, filed on Feb. 2, 2010, the contents of which are incorporated herein by reference in their entirety for all purposes.

This application is also related to U.S. patent application Ser. Nos. 12/630,102, filed on Dec. 3, 2009, entitled Energy Efficient Lighting System and Method, and 12/630,074, filed on Dec. 3, 2009, entitled Electrical Panel, both of which are incorporated herein by reference in their entireties for all purposes.

### BACKGROUND

1. Technical Field

This invention relates to a system of networked, sensor equipped light fixtures.

2. Background Information

There is a need to track movements of people in various types of buildings. Tracking such movements may be advantageous from a safety standpoint, such as to identify the presence of building occupants in the event of a fire. Other applications may include tracking shoppers' movements in a store in order to analyze traffic patterns for the purpose of product placement. One large retail chain recently found, for instance, that sales of breath strips were particularly sensitive to their placement relative to customer traffic patterns in their stores, with up to 80% higher sales depending on location within the store. After moving the breath strips to the same, optimal location in all of its stores, sales increased by several millions of dollars a year.

A need exists for a method and system that facilitates tracking the movement of individuals within buildings or other structures.

### SUMMARY

According to one aspect of the invention, a lighting system is provided for tracking movement within a predetermined area. This system includes a plurality of lights installed at predetermined locations throughout the predetermined area, each having at least one sensor with a field of view. The lights include a computing module operatively associated with each sensor, and a communication module operatively associated with the computing module. The lights are configured to communicate with one another and capture sensor output to identify and record points at which the fields of view overlap with one another, to form a unified sensor network having a composite field of view.

In another aspect of the invention, a method for operating the above-described lighting system includes moving a target sequentially through the fields of view of each of the lights, and generating a signal when the target is detected within the sensor's field of view. The signal is captured and recorded with at least one computing module. The method also included identifying points at which the target is simultaneously located within the fields of view of two or more sensors. The position of each of the identified points relative to one another are recorded in at least two-dimensional coordinates to form a unified sensor network having a composite field of view which incorporates the fields of view of each of the sensors.

In yet another aspect of the present invention, an article of manufacture for operating a plurality of sensor equipped lights, includes a computer usable medium having a computer readable program code embodied therein, for capturing and recording a signal generated by the sensors, identifying points at which a target is simultaneously located within the fields of view of two or more of the sensors, and recording the position of each of said identified points relative to one another in at least two-dimensional coordinates to form a unified sensor network having a composite field of view which incorporates the fields of view of each of the sensors.

The features and advantages described herein are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

### BRIEF DESCRIPTION OF THE DRAWINGS

FIG. 1 is a perspective view of a smart light useful in embodiments of the present invention;

FIG. 2 is a perspective view of the light of FIG. 1, with notional grids depicting the field of view thereof, at representative elevations;

FIG. 3 is a view similar to that of FIG. 2, for a plurality of lights with overlapping fields of view;

FIG. 4 is a plan view of one of the grids of FIGS. 2 and 3, with a tracked individual shown thereon;

FIG. 5 is a view similar to that of FIG. 4, with overlapping grids;

FIG. 6 is a view similar to that of FIG. 5, showing movement of the tracked individual;

FIG. 7 is a view similar to that of FIG. 2, for an alternate embodiment of the present invention;

FIG. 8 is a view similar to that of FIG. 3, for the embodiment of FIG. 7; and

FIG. 9 is a view similar to that of FIG. 5, for the embodiment of FIGS. 7 and 8.

### DETAILED DESCRIPTION

In the following detailed description, reference is made to the accompanying drawings that form a part hereof, and in which is shown by way of illustration, specific embodiments in which the invention may be practiced. These embodiments are described in sufficient detail to enable those skilled in the art to practice the invention, and it is to be understood that other embodiments may be utilized. It is also to be understood that structural, procedural and system changes may be made without departing from the spirit and scope of the present invention. In addition, well-known structures, circuits and techniques have not been shown in detail in order not to obscure the understanding of this description. The following detailed description is, therefore, not to be taken in a limiting sense, and the scope of the present invention is defined by the appended claims and their equivalents. For clarity of exposition, like features shown in the accompanying drawings are indicated with like reference numerals and similar features as shown in alternate embodiments in the drawings are indicated with similar reference numerals.

Where used in this disclosure, the term “axial” when used in connection with an element described herein, refers to a direction relative to the element, which is substantially parallel to its longitudinal axis and/or line of sight. Similarly, the term “transverse” refers to a direction other than substantially parallel to the axial direction. The term “computer” or “computing module” is meant to encompass any suitable computing device including a processor, a computer readable medium upon which computer readable program code (including instructions and/or data) may be disposed, with or without a user interface. Terms such as “module” and the like are intended to refer to a computer-related component, including hardware, software, and/or software in execution. For example, a module may be, but is not limited to being, a process running on a processor, a processor including an object, an executable, a thread of execution, a program, and a computer. Moreover, the various components may be localized on one computer and/or distributed between two or more computers. The term “real-time” refers to sensing and responding to external events nearly simultaneously (e.g., within milliseconds or microseconds) with their occurrence, or without intentional delay, given the processing limitations of the system and the time required to accurately respond to the inputs.

Embodiments of the system and method of the present invention, including various modules thereof, may be programmed in any suitable language and technology, such as, but not limited to: C++; Visual Basic; Java; VBScript; Jscript; BCMAscript; DHTM1; XML and CGI. Alternative versions may be developed using other programming languages including, Hypertext Markup Language (HTML), Active ServerPages (ASP) and Javascript. Any suitable database technology can be employed, but not limited to: Microsoft Access, Microsoft SQL Server, and IBM AS 400.

Referring now to the appended Figures, embodiments of the present invention will be described. Various embodiments provide for the unification of image sensors placed throughout a building or other predetermined area to create in effect one large unified sensor. For ease of explanation, these embodiments will be shown and described as applied to an array of networked light systems (fixtures) such as disclosed in U.S. patent application Ser. No. 12/630,102, filed on Dec. 3, 2009, entitled Energy Efficient Lighting System and Method (the '102 application), and Ser. No. 12/630,074, filed on Dec. 3, 2009, entitled Electrical Panel (the '074 application), both of which are incorporated herein by reference in their entireties for all purposes. As disclosed therein, these light systems include integral electromagnetic sensors such as CCD (charged-coupled device), CMOS (complementary metal-oxide semiconductor), APS (active-pixel sensor), PIR (passive infrared), and/or EM (electro-magnetic) sensors. These light systems also include computing modules and communication modules with IP addresses or the like, so that they may communicate with one another over a network.

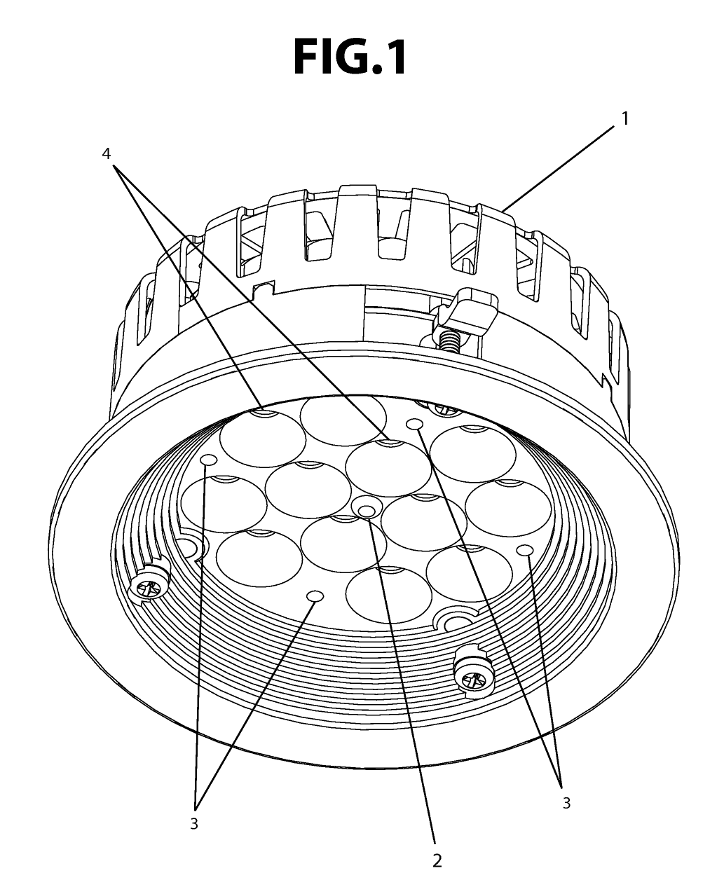

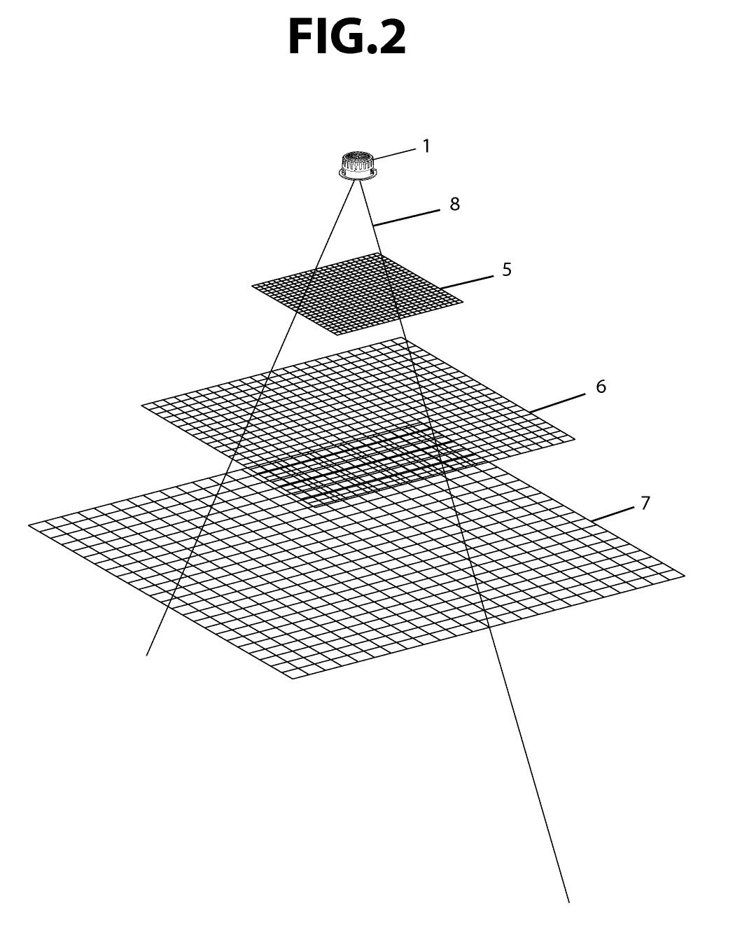

Turning now to FIG. 1, an example of such a light system 1 includes one or more sensors 2 (e.g., CCD, CMOS, APS), PIRs 3 and LED lighting elements 4. As shown in FIG. 2, each light fixture 1 is provided, via its sensor 2, with a field of view which extends transversely from a line of sight of sensor 2. As shown schematically by divergent lines 8, the field of view of sensor 2 tends to increase with distance (e.g., along the line of sight) from the light. As shown, divergent lines 8 represent the outermost boundary of the field of view at any particular point along the line of sight. In the embodiment shown, lines 8 are disposed at an angle of approximately 60 degrees to one another, though this angle of divergence may be sensor-specific, and/or otherwise range anywhere from about 30 to about 75 degrees. The increasing field of view is shown schematically by substantially planar grids 5, 6 and 7 which successively increase in size in proportion to their distances from the light 1 along the line of sight of sensor 2.

It is noted that in the embodiments shown and described, sensors 2 are provided with fixed lenses, so that the angle by which the lines 8 diverge is fixed. It should be recognized, however, that adjustable lenses may be used, so that the angle of divergence may be adjusted as desired. Regardless of whether of not the divergence angle is fixed or adjustable, the light systems may identify and keep track of the angle currently applicable to the sensors to facilitate accurate tracking in 3-D space of objects within the fields of view, as discussed hereinbelow.

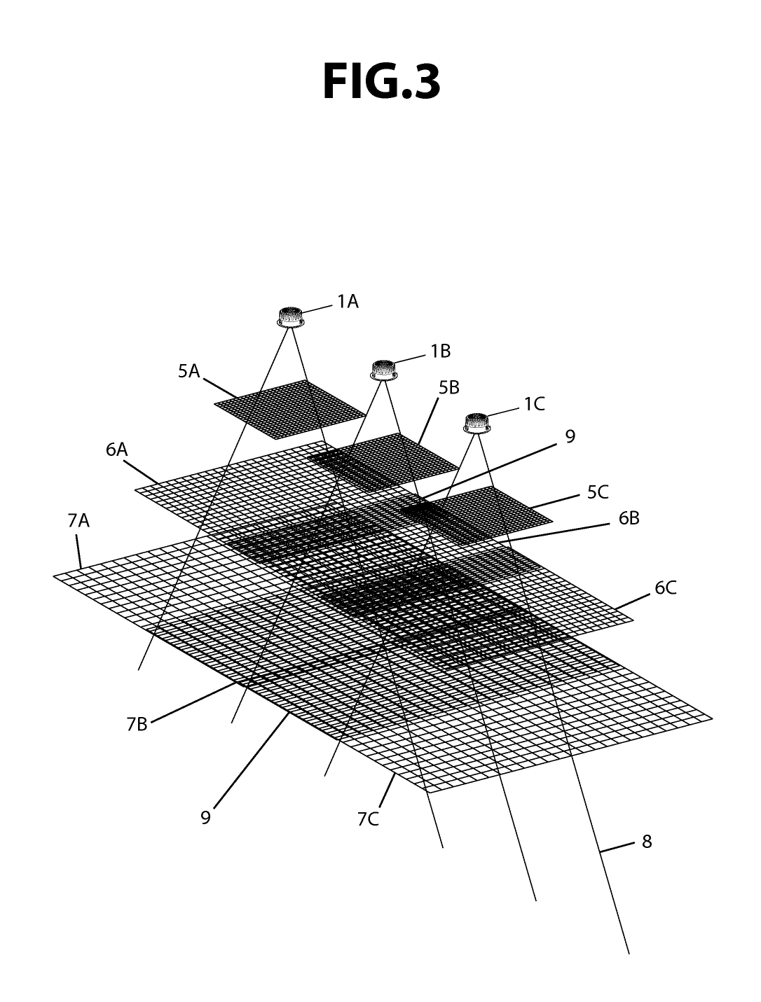

Referring now to FIG. 3, an array of lights 1, such as may be installed in the ceilings of rooms within a building, are shown as lights 1A, 1B and 1C, each having their own field of view grids shown respectively at 5A, 6A, 7A; 5B, 6B, 7B; and 5C, 6C, 7C. As also shown, the lights are spaced so that their field of view grids overlap at predetermined distances from the lights. In the example shown, the grids closest to the lights, 5A, 5B and 5C, do not overlap, while mutually adjacent grids disposed further from the lights may intersect one another, such as at areas shown generally at 9. These mutually intersecting view grids enable an array of lights 1 to be linked to one another to provide a substantially continuous, composite (linked) field of view. Lights 1 may thus provide a composite field of view that extends substantially continuously throughout any area in which lights 1 are installed.

The lights may be calibrated and communicably coupled to one another using any number of suitable methods. One exemplary method includes placing the lights in calibrate mode and moving a target, such as a pinpoint heat and/or light source (or virtually anything that can be seen by the sensors 2), from the field of view of one light to the next, etc. In particular embodiments, this target is maintained within a predetermined transverse (e.g., horizontal) plane, e.g., height, relative to the lights as it is moved, to facilitate accurate calibration. It may be desirable to complete this process at least twice, at two different heights, such as at the level of field of view 6, 6A, 6B, 6C, etc., and at the level of field of view 7, 7A, 7B, 7C, etc., as shown in FIG. 3.

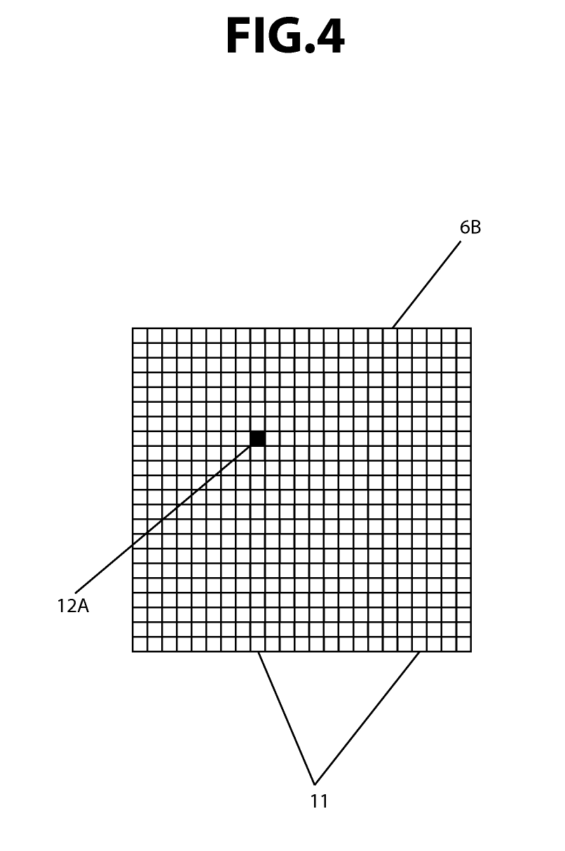

Turning now to FIG. 4, a target 12A is shown within field of view grid 6B of light 1B (FIG. 3). It will be understood that this grid 6B is at a known distance from the light 1B and/or from the floor of the room in which light 1B is installed.

As mentioned above, the field of view of the sensor expands as the distance from the light increases. The number of pixels 11 in the grid is based on the resolution of the CCD or other type of sensor. A 506 pixel resolution is shown for the sake of illustration but the resolution can be in the megapixel range for increased resolution.

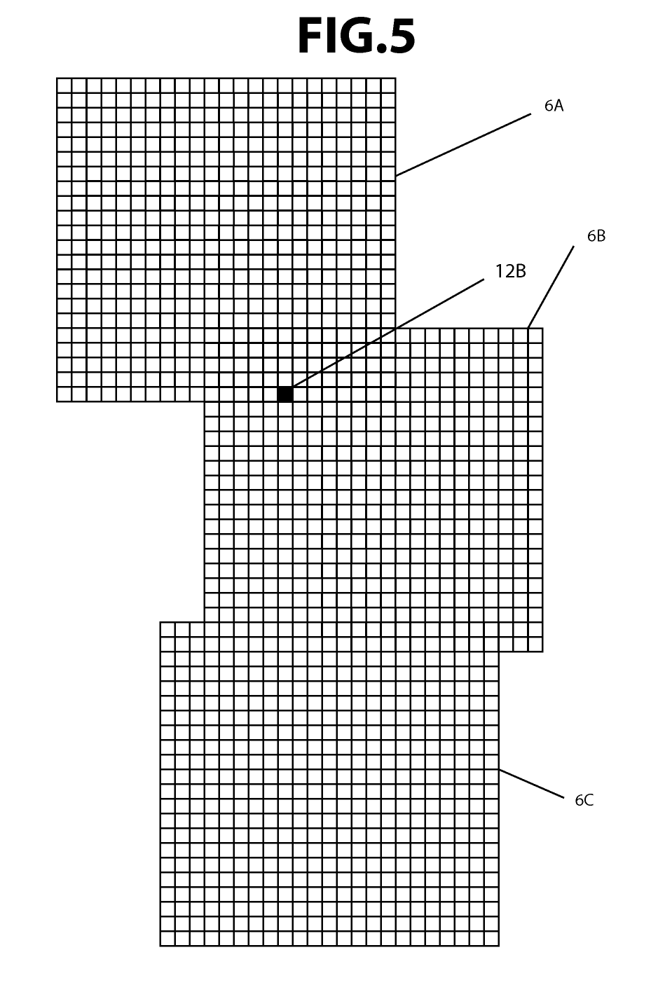

Referring now to FIG. 5, overlapping grids 6A, 6B, 6C of a representative installation of lights 1A, 1B, 1C (FIG. 2) are shown with a calibrating target 12B moving from grid 6B to grid 6A. While in calibrate mode the lights are configured to communicate with one another. The lights are configured to broadcast a signal, e.g., in real-time, in the event the target is within its field of view. When adjacent lights simultaneously capture the presence of the target, the particular pixels 11 triggered by the target are identified (e.g., using X and Y coordinates) and recorded as overlapping with one another. The predetermined height (Z coordinate) of the target may also be recorded.

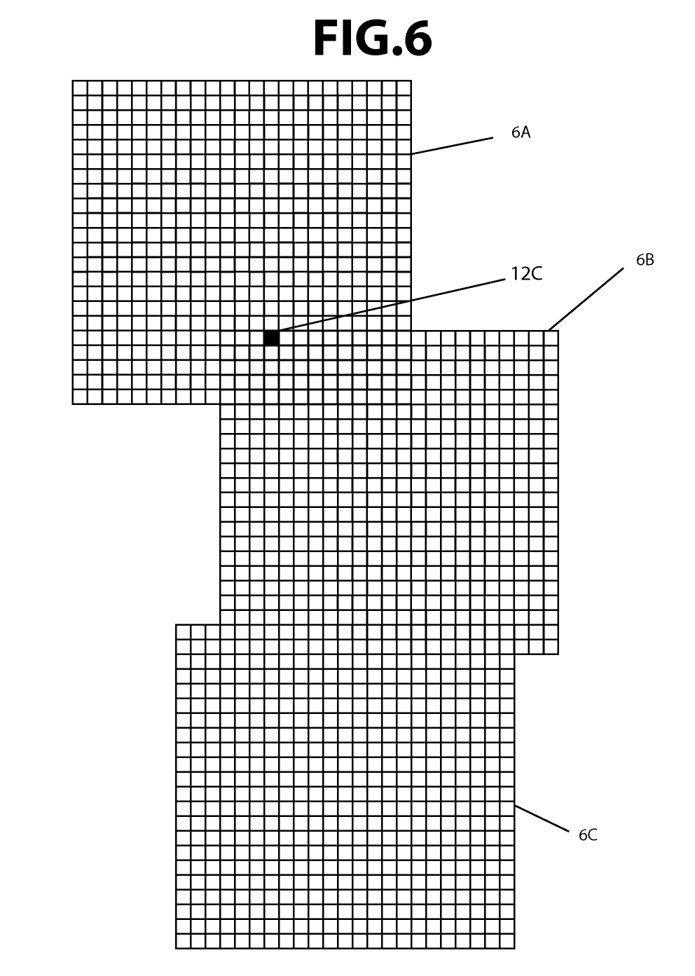

Referring now to FIG. 6, the target, shown at 12C, has moved to another location which overlaps two of the grids (6A and 6B). The overlapping pixels are again recorded in X, Y and Z coordinates. With the identification of at least two overlapping pixels, e.g., as shown in FIGS. 5 and 6, the grids (e.g., 6A and 6B) from two lights (1A, 1B) can now be mathematically orientated to one another based on the predetermined height of the target. The greater the number of overlapping pixels, the more precise the calibration and orientation of the grids.

It should be recognized that in particular embodiments, the times at which the individual sensors are triggered by the target may be captured and stored to a database or other memory device associated with the computing modules of the lights. These time stamps may be used to determine the direction of movement of the target through the various fields of view. This time and direction information may thus be used with or without height information to determine positions of the lights relative to one another. This relative position information may enable the fields of view to be linked to form the composite field of view without the need to repeat the calibration process at multiple elevations.

It is recognized that in some applications it may be desirable to generate a composite field of view that has higher accuracy and/or resolution than that provided by a single pass of a unitary target through the fields of view. In these instances, the target may be passed through the fields of view again at a different height (Z) to provide another set of overlapping pixel locations, such as along the grids of level 7 in FIG. 3 (e.g., grids 7A, 7B, 7C). Completion of these operations using targets moved through the fields of view at least two distinct heights, provide the networked lights with X, Y, and Z axis coordinates for each point of overlap. This data may then be used to calculate the overlap of the fields of view in three dimensional space.

It should be understood that the aforementioned calibration is not limited to moving a single target through the various fields of vision at one height and then optionally again at another height. Many alternate approaches may be used, such as for example, using a bar or other tool having two or more targets spaced a predetermined distance from one another thereon. A user may then orient the bar/tool so that the targets are disposed at different elevations (heights), and then while maintaining this orientation, move the tool through the various fields of view as discussed above. In this manner, a user need only make a single pass through the fields of view.

In a variation of the above approach, targets may be spun on a disk and passed through the fields of view. As the disk passes through overlapping portions of the fields of view, it may pass through locations in which adjacent light systems 1, 1A, etc., identify a pair of overlapping pixels at a first undetermined height, and another pair of overlapping pixels at a second undetermined height. (It is expected that additional pairs of overlapping pixels may also be identified as the disk rotates about its axis, e.g., due to the well known persistence of vision effect.) As the two targets rotate, the light systems may calculate the three dimensional position (e.g., along X, Y and Z axes) of the targets, based on the apparent maximum distance between the targets, and/or in combination with the known angle of divergence (e.g., of lines 8, FIG. 2) of the individual fields of view.

In particular embodiments, the calibration process continues until the target(s) has moved through all the fields of view of the installed light systems 1, 1A, etc., to effectively connect all of the light systems together into one large 2D or 3D composite field of view/grid. Once this process is completed, the lights may continue to self calibrate when two or more light systems see the same heat signature. In this manner, for example, the individual light systems/fixtures may be configured to re-calibrate in the event a single person passing through the field of view of one fixture appears simultaneously at an unexpected pixel location of an overlapping field of view of an adjacent fixture.

Still another approach for calibration is to program each light 1, 1A, etc., with its approximate location relative to surrounding light systems. With this location information, overlapping pixels may be identified automatically when an individual or other target is viewed simultaneously by adjacent lights.

Once the installed lights 1, 1A, etc., have been calibrated as discussed above, the fields of view of the various lights will be effectively linked to one another to form a unified sensor network having a composite field of view made up of the fields of view of the various lights. This unified sensor network may then be used to track movement of people or other objects therethrough.

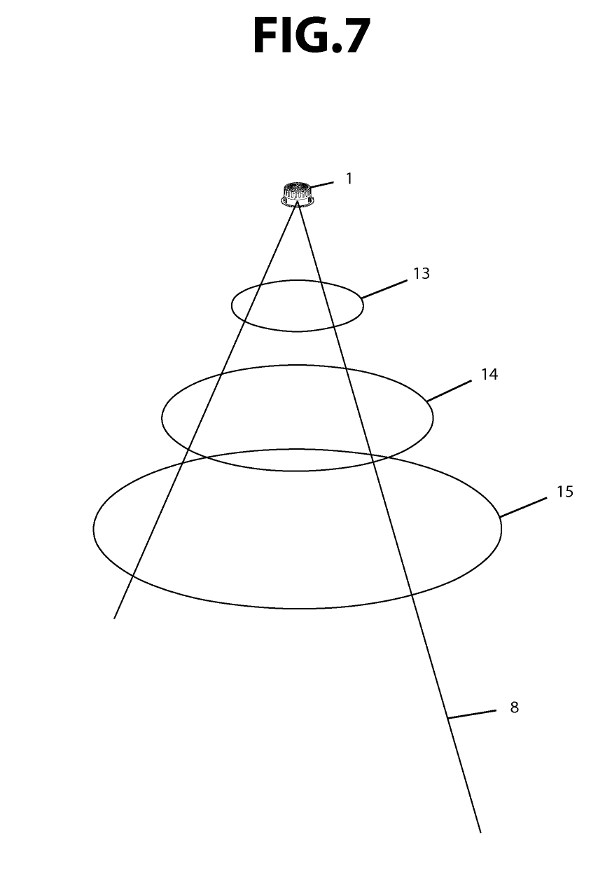

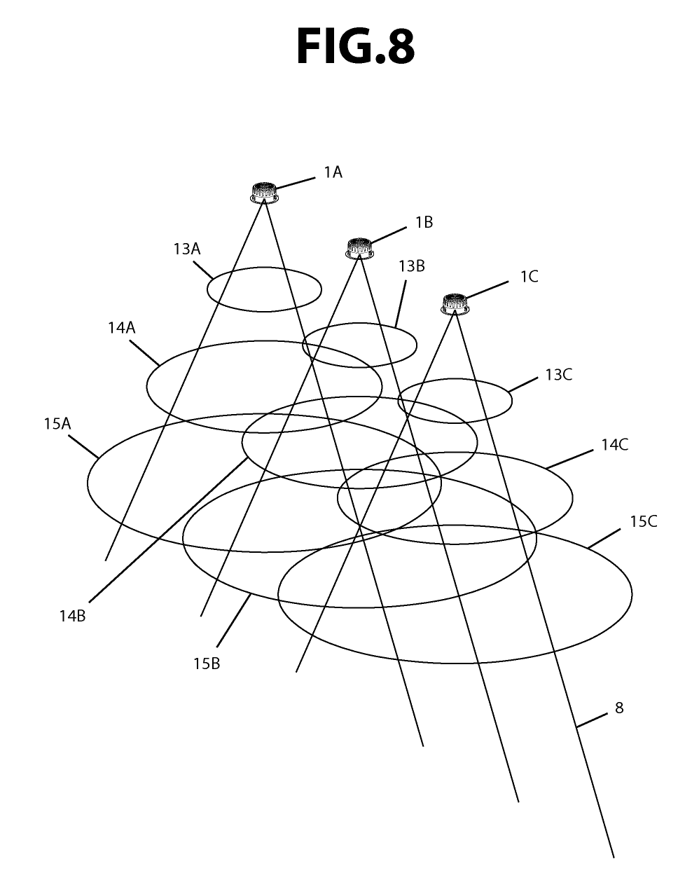

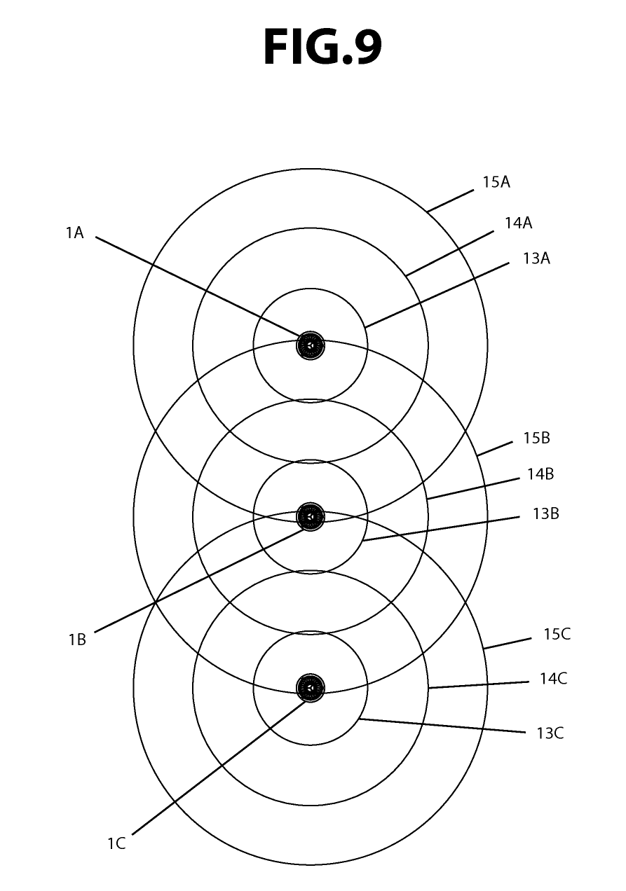

Turning now to FIG. 7, instead of image based sensors, other embodiments of the present invention may use non-image based sensors to track targets. For example, lights 1, 1A, etc., may use passive infrared sensors 3 (FIG. 1) to track movement of people or objects. The field of view of such sensors expands in a manner similar to that shown and described hereinabove with respect to sensors 2, e.g., along divergent lines 8 as shown. This field of view of a single sensor 3 is shown schematically at three different elevations 13, 14 and 15. The fields of view of an array of lights 1A, 1B, 1C, etc., including any overlap, are shown at 13A-C, 14A-C and 15A-C of FIGS. 8 and 9.

In this approach, the lights may be initially programmed with their approximate locations relative to surrounding light systems as discussed above. As a target moves into the field of view, the location of the target may be calculated by tracking which sensors 3 are activated, in combination with the known location of the lights 1, 1A, etc.

Moreover, and/or in the alternative, in any of the embodiments discussed herein, the speed and location of the target may be determined by successive sampling of the output of the sensors 2, 3. Each sample may be time stamped, to effectively track the time the target takes to move from one location to the next, e.g., from the field of view of one light system, to the field of view of an adjacent light system. Those skilled in the art will recognize that the accuracy and/or resolution of such tracking may be dependent on the resolution of the particular sensors used. Thus, in some embodiments, the image-based CCD sensors of FIGS. 2-6 may be expected to provide greater tracking accuracy and/or resolution than the non image-based PIR sensors shown and described with respect to FIGS. 7-9. Depending on the resolution of the particular sensors used, and the density of light systems, i.e., the number of lights 1, 1A, etc., deployed within an particular area, the presence and direction of movement of multiple room the occupants may be tracked.

Exemplary methods in accordance with the present invention are shown and described with respect to Tables I and II hereinbelow. As shown, the method includes moving 100 a target sequentially through the fields of view of each of the lights, and generating 102, with a sensor, a signal when the target is detected within the sensor's field of view. At 104, the signal is captured and recorded. Points are identified 106 at which the target is simultaneously located within the fields of view of two or more sensors. The position relative to one another of each of the identified points is recorded at 108 to form a unified sensor network having a composite field of view which incorporates the fields of view of each of the sensors.

Turning now to Table II, various optional aspects of the foregoing method are shown and described. At 110, the recording may include recording the position of each of said identified points relative to one another in three-dimensional coordinates. At 112, moving may include maintaining the target at a first elevation, and then repeating with the target disposed at a second elevation. At 114, the moving may include simultaneously moving two or more targets, each disposed at mutually distinct elevations, through the fields of view. At 116, the identifying may include using the predetermined viewing angle of the sensors. At 118, the identifying may include broadcasting a signal to the network in real-time, with the identity of any sensor as it is triggered by the target. At 120, the identifying may include recording as overlapping, the fields of view of any sensors broadcasting said signal simultaneously. At 120, the identifying may include identifying overlapping pixels within the overlapping fields of view. At 122, calibration of the lights may be updated by repeating steps 102-108 when sensors of at least two lights are simultaneously triggered by an object passing through the composite field of view. At 124, the lights may be programmed with their installed locations relative to one another. At 126, individuals may be tracked as they move through the composite field of view. At 128, movement of individuals through the composite field of view may be captured sequentially and time-stamped, to track speed and direction.

TABLE I

| | |
|---|---|
| 100 | move target sequentially through the fields of view |
| 102 | generate signal when the target detected |
| 104 | capture and record signal |
| 106 | identify points at which the target is simultaneously located |
| 108 | record position of each identified point relative to one another |

TABLE II

| | |
|---|---|
| 110 | maintain target at a first elevation and repeat with the target |
| | at a second elevation |
| 112 | simultaneously move two or more targets, each at distinct |
| | elevations |
| 114 | use sensor viewing angle |
| 116 | broadcast a signal in real-time, with identity of any triggered |
| | sensor |
| 118 | recording as overlapping, the fields of view of simultaneously |
| | broadcasting sensors |
| 120 | identifying overlapping pixels |
| 122 | updating calibration by repeating 102-108 |
| 124 | programming lights with installed locations |
| 126 | tracking the movement of individuals through composite |
| | field of view |
| 128 | capturing data sequentially to track speed and direction |
| | of the individuals |

It is noted that light systems 1, 1A, 1B, etc., may be provided with more than one sensor, such as the multiple sensors 3 shown in FIG. 1. While a single sensor may prove sufficient to implement aspects of the embodiments shown and described herein, in some applications, the use of more than one sensor in each light system may be used to relatively improve the accuracy/resolution of tracking.

It should be noted that the various modules and other components of the embodiments discussed hereinabove may be configured as hardware, as computer readable code stored in any suitable computer usable medium, such as ROM, RAM, flash memory, phase-change memory, magnetic disks, etc., and/or as combinations thereof, without departing from the scope of the present invention. Additional examples of a suitable computer storage medium include any of, but not limited to, the following: CD-ROM, DVD, magnetic tape, optical disc, hard drive, floppy disk, ferroelectric memory, flash memory, ferromagnetic memory, optical storage, charge coupled devices, magnetic or optical cards, smart cards, EEPROM, EPROM, RAM, ROM, DRAM, SRAM, SDRAM, and/or any other appropriate static or dynamic memory or data storage devices.

The above systems, modules, etc., may be implemented in various computing environments. For example, embodiments of the present invention may be implemented on a conventional IBM PC or equivalent, multi-nodal system (e.g., LAN) or networking system (e.g., Internet, WWW, wireless web). All programming and data related thereto are stored in computer memory, static or dynamic or non-volatile, and may be retrieved by the user in any of: conventional computer storage, display (e.g., CRT, flat panel LCD, plasma, etc.) and/or hardcopy (i.e., printed) formats. The programming of these embodiments may be implemented by one skilled in the art of computer systems and/or software design based on the teachings herein.

It should be understood that any of the features described with respect to one of the embodiments described herein may be similarly applied to any of the other embodiments described herein without departing from the scope of the present invention.

In the preceding specification, the invention has been described with reference to specific exemplary embodiments for the purposes of illustration and description. It is not intended to be exhaustive or to limit the invention to the precise form disclosed. Many modifications and variations are possible in light of this disclosure. It is intended that the scope of the invention be limited not by this detailed description, but rather by the claims appended hereto.

Having thus described the invention, what is claimed is:

1. A lighting system for tracking movement within a predetermined area, the system comprising:
a plurality of lights installed at predetermined locations throughout the predetermined area;
each of the plurality of lights including at least one sensor having a field of view;
each of the plurality of lights further including a computing module operatively associated with each sensor and a communication module operatively associated with the computing module;
the communication modules of each of said plurality of lights being configured to communicate with one another to form a network;
the lights being configured to communicate via the network, and using the computing modules, capture sensor output to identify and record points at which the fields of view overlap with one another, wherein the networked lights form a unified sensor network having a composite field of view.

2. The system of claim 1, wherein at least one of said computing modules is configured to record the position of said points relative to one another in three-dimensional coordinates.

3. The system of claim 2, being configured to simultaneously track at least two targets, each disposed at mutually distinct elevations, as they move through the fields of view.

4. The system of claim 3, wherein the sensors have a viewing angle ranging from about 30 degrees to about 75 degrees.

5. The system of claim 2, wherein the computing modules are configured to broadcast a signal to the network in real-time, with the identity of any sensor as it is triggered by the target.

6. The system of claim 5, wherein the computing modules are configured to record as overlapping, the fields of view of any sensors broadcasting a signal simultaneously.

7. The system of claim 6, wherein the computing modules are configured to identify overlapping pixels within the overlapping fields of view.

8. The system of claim 1, being configured to update the points at which the fields of view overlap when sensors of at least two lights are simultaneously triggered by an object passing through the composite field of view.

9. The system of claim 1, wherein the computing modules are configured for being programmed with the installed locations of the lights relative to others of said lights.

10. The system of claim 1, being configured to track the movement of individuals through the composite field of view.

11. The system of claim 10, wherein the computing modules are configured to capture and time-stamp sensor output sequentially, to track speed and direction of the individuals moving through the composite field of view.

12. A method for operating a system of sensor equipped lights, the method comprising:
(a) moving a target sequentially through the fields of view of each of the lights of claim 1;
(b) generating, with a sensor, a signal when the target is detected within the sensor's field of view;
(c) capturing and recording the signal with at least one computing module;
(d) identifying points at which the target is simultaneously located within the fields of view of two or more sensors;
(e) recording the position of each of said identified points relative to one another in at least two-dimensional coordinates to form a unified sensor network having a composite field of view which incorporates the fields of view of each of the sensors.

13. The method of claim 12, wherein said recording (e) further comprises recording the position of each of said identified points relative to one another in three-dimensional coordinates.

14. The method of claim 13, wherein said moving (a) further comprises maintaining the target at a first elevation during said moving; and said method further comprises repeating said moving (b) with the target disposed at a second elevation.

15. The method of claim 13, wherein said moving (a) comprises simultaneously moving two or more targets, each disposed at mutually distinct elevations, through the fields of view.

16. The method of claim 15, wherein said identifying (d) further comprises using a predetermined viewing angle of the sensors.

17. The method of claim 13, wherein said identifying (d) further comprises broadcasting a signal to the network in real-time, with the identity of any sensor as it is triggered by the target.

18. The method of claim 17, wherein said identifying (d) further comprises recording as overlapping, the fields of view of any sensors broadcasting said signal simultaneously.

19. The method of claim 18, wherein said identifying (d) further comprises identifying overlapping pixels within the overlapping fields of view.

20. The method of claim 12, further comprising updating calibration by repeating said (b)-(e) when sensors of at least two lights are simultaneously triggered by an object passing through the composite field of view.

21. The method of claim 12, further comprising programming the plurality of lights with their installed locations relative to others of said lights.

22. The method of claim 12, comprising tracking the movement of individuals through the composite field of view.

23. The method of claim 22, wherein said capturing (c) is effected sequentially and is time-stamped, to track speed and direction of the individuals moving through the composite field of view.

24. An article of manufacture for operating a plurality of sensor equipped lights, said article of manufacture comprising a computer usable medium having a computer readable program code embodied therein, for:
capturing and recording a signal generated by the sensors;
identifying points at which a target is simultaneously located within the fields of view of two or more of the sensors;
recording the position of each of said identified points relative to one another in at least two-dimensional coordinates to form a unified sensor network having a composite field of view which incorporates the fields of view of each of the sensors.
